(19) United States
(12) Patent Application Publication
(10) Pub. No.: US 2020/0296089 A1
(43) Pub. Date: Sep. 17, 2020

(54) VALIDATING CONTAINERS ON A MICROSERVICE FRAMEWORK

(71) Applicant: INTERNATIONAL BUSINESS MACHINES CORPORATION, Armonk, NY (US)

(72) Inventors: Wei-Hsiang Hsiung, Taipei (TW); Cheng-Ta Lee, Taipei (TW); Wei-Jie Liau, Taoyuan (TW); Chun-Shuo Lin, Tainan (TW)

(21) Appl. No.: 16/354,244

(22) Filed: Mar. 15, 2019

(51) Int. Cl. H04L 29/06; H04L 9/32; G06F 21/44

(52) U.S. Cl. CPC H04L 63/0823; G06F 21/44; H04L 9/3236; H04L 63/061

(57) ABSTRACT

A method, computer system, and a computer program product for verification and authentication in a microservice framework is provided. The present invention may include configuring a container within a microservice framework. The present invention may also include receiving a generated salt file. The present invention may then include injecting the salt file into the container. The present invention may further include hashing the container image and the salt file.

### BACKGROUND

The present invention relates generally to the field of computing, and more particularly to authentication. A microservice framework may be structured with smaller independent architectural components that operate at high speed. The independent components may perform a focused operation, however, the other independent components in the same microservice framework may operate using differing technologies. The independent scalability of microservices allows a service to offer multiple cloud-based products using a larger number of resources.

### SUMMARY

Embodiments of the present invention disclose a method, computer system, and a computer program product for verification and authentication in a microservice framework. Embodiments of the present invention may include configuring a container within a microservice framework. Embodiments of the present invention may also include receiving a generated salt file. Embodiments of the present invention may then include injecting the salt file into the container. Embodiments of the present invention may further include hashing the container image and the salt file.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for two-factor authentication on a microservice framework according to at least one embodiment;

FIG. 3 is an operational flowchart illustrating a process for integrity validation on a microservice framework according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a system, method and program product for authentication in a microservice framework. As such, Embodiments of the present invention have the capacity to improve the technical field of authentication by enhancing security on a microservice framework using a software-based solution. More specifically, enhancing the security procedures will allow for the secure transfer of server certificates between microservice frameworks, containers, client devices and cloud services by incorporating multi-factor authentication steps and validation steps. Since embodiments of the present invention are implemented in software, a microservice framework provider may have more flexibility and may receive benefits of the added security with the option not to integrate the software-based solution.

As previously described, a microservice framework may be structured with smaller independent architectural components that operate at high speed. The independent components may perform a focused operation, however, the other independent components in the same microservice framework may operate using differing technologies. The independent scalability of microservices allows a service to offer multiple cloud-based products using a larger number of resources. A microservice framework may also be known as a host, a microservice management framework or a container host. A microservice may include, for example, a separate software component that may perform a smaller function than the whole software application. A service may include, for example, a software service or software as a service (SaaS) that provides a service to a client, such as services, licensing, subscription or an on-demand software.

Many microservice frameworks operate using a container-based infrastructure. Containers may include isolated infrastructures that use a minimal amount of resources, share a host operating system and are simple to integrate. Containers also allow for minimal software configuration since the container may use, for example, the same software code in a delivery pipeline. A differing container may operate within the same microservice framework and operate an alternate software code with minimal configuration. One example of a container platform may include Docker® containers (Docker and all Docker—based trademarks and logos are trademarks or registered trademarks of Docker, Inc. and/or its affiliates).

Microservice frameworks may use a container to represent a trusted entity. For example, if a container needs to access a cloud service, an application programming interface (API) key is required. The API key may either be transmitted into the container via an environment variable or may show up in a configuration information file (config file) in a shared volume. This may cause the software as a service (SaaS) provider to have no interaction with the remote entity once the API is issued. Remote entities may include remote servers, remote databases and remote sources.

An API may include a set of functions or a communication protocol that allows, for example, the container to access data on a virtual machine, an operating system, a service or an application. An API key may include an identifying code transmitted to an API. The identifying code may include authentication steps using a unique identifier and a token to prevent unauthorized use.

An environment variable may be set at a microservice framework machine and transmitted or passed from the microservice framework to a container. The environment variable may include a process that the container will operate using minimal software configuration. A config file may define parameters or preferences or a particular program or application. For example, when starting a Docker® container, environment variables that may be transmitted to the new container could include the remote SaaS Internet Protocol (IP) address, the host name of the remote SaaS and the credentials for accessing the remote SaaS, such as an API key. Additionally, key value pairs may also be transmitted to a new container. An example environment variable may include $ docker run -e API_HOST=domain.com -e API_EY=123456 myimage:latest.

Providing plain text credentials in an environment variable may not secure the environment variable if an unauthorized individual, such as a hacker, were to gain access to the plain text credentials. One way to secure an environment variable may be to use encryption methods or to store credentials, such as the API key, in a secured vault and pass a decryption key through the environment variable. One issue that may still arise when passing the decryption key through the environment variable may include the credentials showing up as plain text data at some point through the transmission of data, possibly in the memory or on a disk.

If an environment variable is leaked or a shared volume is misconfigured, then the hacker may spin up the same container and gain access to the cloud service. A root cause of the potential security breach may result from every mechanism used to improve security operates in one place or location and there may be no additional interaction between the container and the cloud service, creating a security risk for the services and the users of the services. Therefore, it may be advantageous to, among other things, add security features using authentication and validation procedures between a microservice framework, a container a service and a client device.

According to an embodiment, two-factor authentication may be leveraged to add an out-of-band channel to the authentication flow between microservice frameworks, containers, services and clients. An out-of-band channel is an independent communication channel in which the two-factor authentication may communicate and transmit data for added security measures. For example, a remote server stores an authentication file that only the container can access via a secondary, out-of-band channel.

A microservice framework or a service running on the microservice framework may have an interface for injecting a file into a running container, such as injecting data into a Docker® utility (e.g., docker cp) container. A cloud service may provide extra security by injecting a file into a container, for example a salt file. A salt file may include a form of cryptography that adds randomly generated data to a file, creating a file that an unauthorized individual would be unable to guess the contents of the randomly generated data. The salt file may be used in calculating a shared secret, for example, adding randomly generated data to a secret key. The shared secret may be used in future communication transmissions between a container and a cloud service. A shared secret (i.e., the secret or the secret data) may include, for example, secret data, secret keys, symmetric keys, asymmetric keys or other data that may be used for identification purposes during authentication and validation.

According to an embodiment, copying and transmitting a salt file to a running container may use an out-of-band channel. The volume (e.g., logical volume) that stores the salt file may be a read-only file to a container, therefore, creating a difficult scenario for an unauthorized individual to forge a salt file. The contents of a salt file may be secure such that even if an unauthorized user obtained an environment variable or a config file, the cloud service may not be accessible to the unauthorized user since the unauthorized user may not obtain the salt file.

A salt file may also be used to create a validation mechanism for remote file integrity. A salt file may be generated using one or more methods. One method may include generating a random file by the SaaS and the SaaS may push the random file back to the host (i.e., microservice framework) that is running the container. One other method may include using a third-party salt service. The SaaS and the microservice framework may interact with the third-party salt service to generate and ingest the salt file. The third-party service may generate the salt file and the microservice framework may ingest and transmit the salt file to the container.

The salt file may contain data relating to the container, the microservice framework or the service. The salt file may also contain a one-time password. The container information may include, for example, a container hash, a file comparison hash (e.g., a diff hash) or a running process hash. The microservice framework information may include data relating to the identity of the microservice framework, such as an internet protocol (IP) address, a host name (i.e., microservice framework name), an operating system name, a kernel version or a list of installed application packages. The microservice framework information may be used and transmitted to one or more entities to ensure validation and integrity of the communication. A container hash example may include a container connecting to a remote SaaS and the remote SaaS has the hash value of the container. The SaaS inserts the container hash information into the salt file and either the container or the microservice framework can use the hash information or the salt file for validation and integrity purposes when a container connects to a service. Service information may include the pre-shared secret.

In an embodiment, an interface for injecting a salt file into a container may also require authentication between a cloud service and a microservice framework. For example, a SaaS may obtain access to the interface to inject the salt file into a volume that is accessible to the container and is readable by the container. The interface may be hosted by the microservice framework, the container or another microservice. For example, a multi-factor authentication interface is generated for a SaaS to inject a static file to a storage used by microservices. A first microservice receives the static file from a SaaS and injects the static file into the storage or the shared volume. The storage or shared volume may be accessible to a second microservice running on the same microservice framework. Since the microservice framework may have authentication permission to insert a file into a microservice and the microservice framework may also have authentication permission to allow other services to insert the file, the authentication interface may be hosted by a varying microservices. The advantage to allowing the authentication interface to be hosted by different microservices may allow the authentication interface to be used across various microservice environments without involving the microservice framework. For example, the microservice framework may receive the benefits of added security without integrating the software into the microservice framework.

In an embodiment, a microservice host may provide an interface to the SaaS and the microservice framework may manage or process the static file injection to various storages used by the microservices. A one-time authorization token may be shared with a microservice and, for example, the SaaS may initiate the authorization process for security purposes for interactions between the microservice and the cloud-based SaaS. For example, a Guardium® Proxy (Guardium and all Guardium—based trademarks and logos are trademarks or registered trademarks of International Business Machines Corporation and/or its affiliates) may leverage this enhanced security feature to securely transfer a server certificate from a Guardium® collector to the Guardium® Proxy to protect enterprise assets.

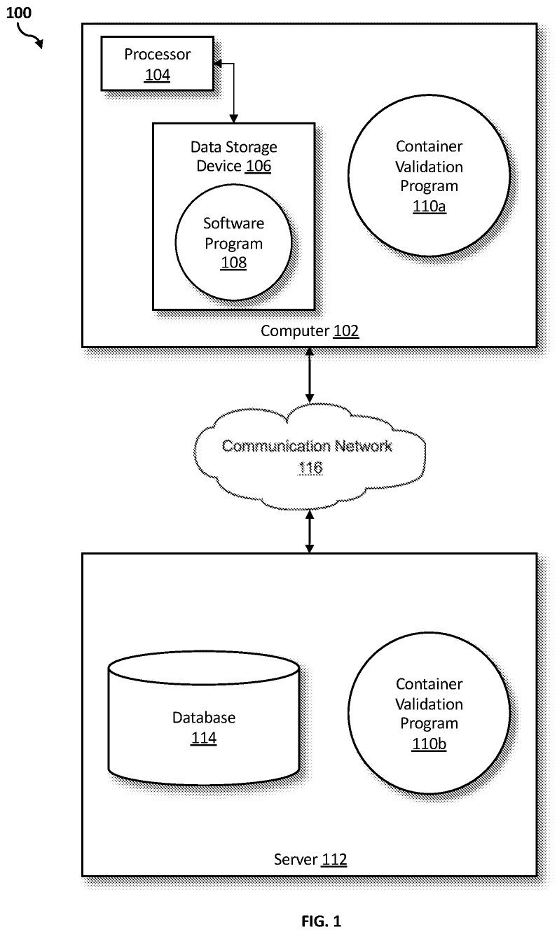

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a container validation program 110a. The networked computer environment 100 may also include a server 112 that is enabled to run a container validation program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

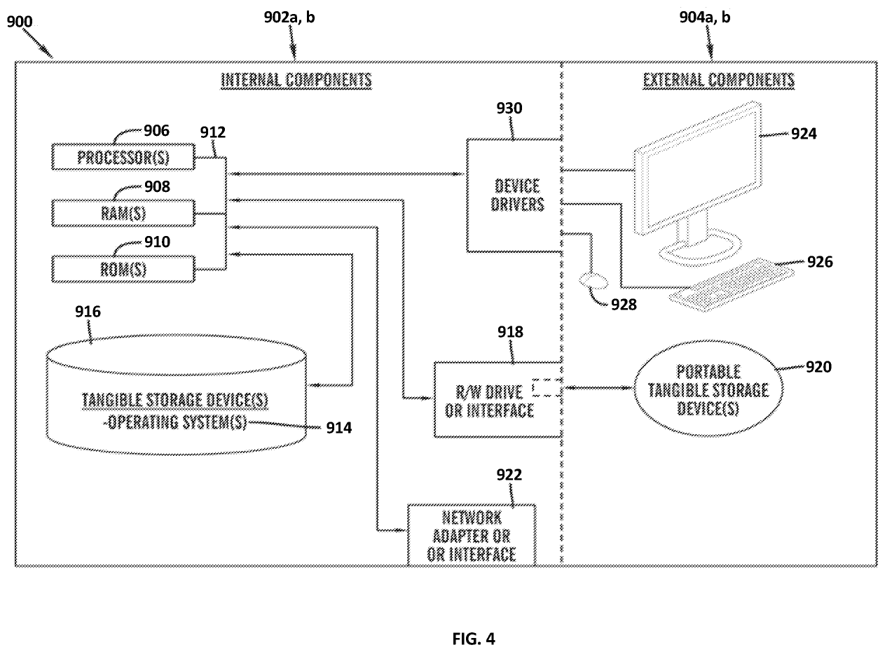

The client computer 102 may communicate with the server computer 112 via the communications network 116. The communications network 116 may include connections, such as wire, wireless communication links, or fiber optic cables. As will be discussed with reference to FIG. 4, server computer 112 may include internal components 902a and external components 904a, respectively, and client computer 102 may include internal components 902b and external components 904b, respectively. Server computer 112 may also operate in a cloud computing service model, such as Software as a Service (SaaS), Analytics as a Service (AaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the container validation program 110a, 110b may interact with a database 114 that may be embedded in various storage devices, such as, but not limited to a computer/mobile device 102, a networked server 112, or a cloud storage service.

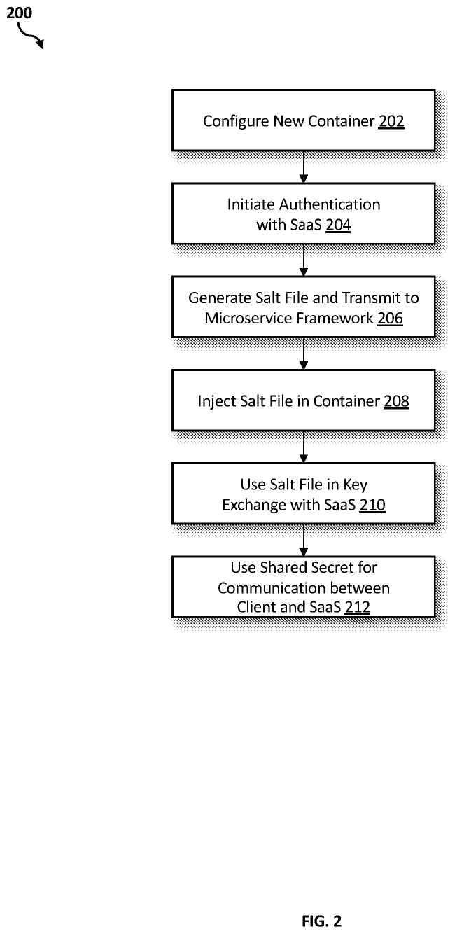

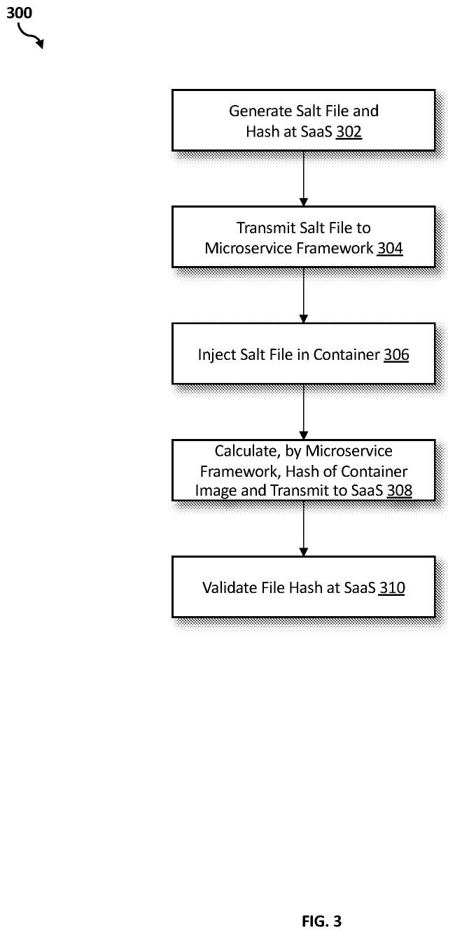

According to the present embodiment, a user using a client computer 102 or a server computer 112 may use the container validation program 110a, 110b (respectively) to provide secure authentication to a microservice framework using containers and communicating with a SaaS. The container validation method is explained in more detail below with respect to FIGS. 2 and 3.

Referring now to FIG. 2, an operational flowchart illustrating the exemplary two-factor authentication on a microservice framework process 200 used by the container validation program 110a, 110b according to at least one embodiment is depicted.

At 202, a new container is configured. A new container may be added to a microservice framework. The microservice framework can define and transmit an environment variable to the new container when spinning up the new container. The environment variable may include a config file that defines the parameters of the container application within the microservice framework.

At 204, authentication with a SaaS is initiated. Initiation may begin with the newly added and configured container. The container may initiate authentication with the SaaS by, for example, using an API host to connect to a remote SaaS and the remote SaaS using an API key to authenticate (e.g., docker run -e API_HOST=domain.com -e API_EY=123456 myimage:latest). Authentication may occur at a transport layer security (TLS) layer or at an application layer. The TLS layer may add an encryption layer for the application layer and may establish an encrypted session. The application layer may specify interface methods and communication protocols.

A TLS handshake protocol may authenticate and provide key exchanges between the microservice framework, the container, the software service or the microservice. An authentication at a TLS layer using the TLS handshake example may include a server that requests a client to provide a client certification for mutual authentication when the container validation program 110a, 110b engages in authentication. The client may be a client of the software service (e.g., the SaaS) and may also be known as a user of the service.

At 206, a salt file is generated and transmitted to a microservice framework. The authenticated SaaS may generate a salt file and transmit the salt file to the microservice framework. The salt file may be a cryptographic hash function and may include random data to add security to authentication in a microservice framework. For example, a server may create a new file to inject into a container and may add special information, secret data or random data strings to the new file before injecting into the container for added security. The secret data may be related to and include, for example, a secret key, a private key, encryption keys, decryption keys, exporter keys or other data created by a user to further protect the data being transmitted.

At 208, the salt file is injected into the container. The microservice framework may inject the salt file received by the SaaS into the container. The microservice framework may allocate storages for containers and the storages may appear as different file folders from the point of view of the microservice framework, creating a simple process to inject the salt file into the container and to copy a salt file from one folder to a different folder. For example, docker cp <location of salt file>destination container ID>:/path/.

An alternate embodiment may include the salt file being injected as a dynamic client certification. Authentication at an application layer may provide flexibility for the salt file creation. Typically, authorization at an application layer validates the API key transmitted from the client, however, the added flexibility includes the ability to request additional information from the client and the requested information may be dynamic. Dynamic information may include, for example, a secondary API key generated based on the salt file injected by the server.

At 210 the salt file is used in a key exchange with the SaaS. A key exchange may occur, for example, in the microservice framework between the container and the SaaS, a client and the SaaS, the SaaS and the container or the microservice and the SaaS. One or more key exchange types may be used, such as a TLS layer key exchange or an application layer key exchange. The TLS key exchange may use a salt file that contains a client certificate during the TLS handshake. The application layer key exchange may use a salt file that contains some parameters that require both sides of the exchange to have the same key information or secret information to allow accessibility. For example, if a SaaS is presented with a salt file that the SaaS injected into a container, then the key would match since the SaaS created the original salt file, and accessibility would be provided.

At 212, the shared secret is used for communication between the client and the SaaS. The shared secret may be communicated or negotiated, for example, between the client and the SaaS server when a client compute device encrypts a payload request and transmits to the SaaS server and in response, the SaaS server decrypts the payload request using the shared secret. The SaaS server may then encrypt and transmit the response to the client payload request and in response, the client may decrypt the payload using the shared secret. The client request and the SaaS response may be looped and in a continuous or a back and forth communication between requests and responses until the transaction is complete. A client compute device may include, for example, a personal computer, a smart phone, a smart tablet or a smart watch.

Referring now to FIG. 3, an operational flowchart illustrating the exemplary integrity validation on a microservice framework process 300 used by the container validation program 110a, 110b according to at least one embodiment is depicted. Integrity validation using the microservice framework may provide added security to verify the container in the microservice framework is the expected container and not a compromised container.

At 302, a salt file is generated and hashed at the SaaS. The SaaS may generate a salt file for integrity validation of the microservice framework. The generated hash may include a hash value calculated using the container file and the salt file. See step 206 for salt file generation by the SaaS.

At 304, the salt file is transmitted to the microservice framework. Once generated by the SaaS in step 302, the salt file is transmitted from the SaaS to the microservice framework. See step 206 for the salt file transmission to the microservice framework.

At 306, the salt file is injected into a container. The salt file may be injected into the container by the microservice framework. See step 208.

At 308, the hash of the container image and the salt file is calculated by the microservice framework and transmitted to the SaaS. In response to receiving the salt file from the SaaS from step 304, the microservice framework may calculate the hash, for example, of the container image and the salt file using sha256 hash generator. The resulting hash created by the microservice framework may be transmitted to the SaaS for validation. Calculating the container hash at the microservice framework may provide a highly secure validation process because, for example, if a container has malware, the container may skip a file and calculate a different hash value when the host may calculate every container file in the hash.

In an alternate embodiment, the hash created by the microservice network may also be created without the salt file (i.e., hash of the container image), however, utilization of the salt file may provide added security since the salt file contains unique data. The microservice framework may then transmit the hash of the container image back to the SaaS for further validation.

In an alternate embodiment, the container appends the salt file to the target files, calculates a file hash and transmits the calculated hash to the SaaS. In response to receiving the injected salt file at step 306, the container may calculate the hash to be transmitted to the SaaS. The hash calculated by the container may include the salt file appended to the target files. The target files may include data that the SaaS requires for an integrity validation step. The target file may include a single file, or the target files may include a folder or the whole container. Calculating the container hash at the container may provide a more flexible approach to validation since the SaaS may request various hashes, such as a hash of the whole container or a hash of a single file. A single file example may include a binary file to initiate the connection to the SaaS.

In an alternate embodiment, the hash created by the container may also be created without the salt file (i.e., hash of the container image), however, utilization of the salt file may provide added security since the salt file contains unique data.

At 310, the hash file is validated at the SaaS. The SaaS may perform an integrity validation step by comparing the hash received from the microservice framework at step 308 with the SaaS calculated hash. The SaaS may also perform an integrity validation step by comparing the hash received from the container at step 310 with the SaaS calculated hash. The SaaS may additionally perform an integrity validation step by comparing the hash received from the microservice framework at step 308 with the hash received by the container from step 310. The SaaS may independently calculate a hash using the salt file with the expected contents of the microservice or the container and the expected values sent from the client. The SaaS may calculate a hash based on what the SaaS is expected to receive, such as a hash of the container and the salt file or a hash of the target file and the salt file.

Without using the integrity validation on a microservice framework process 300, if a microservice framework provides the container image hash to the SaaS without calculating the hash, the container verification of the hash is not validated.

It may be appreciated that FIGS. 2 and 3 provide only an illustration of one embodiment and do not imply any limitations with regard to how different embodiments may be implemented. Many modifications to the depicted embodiment(s) may be made based on design and implementation requirements.

FIG. 4 is a block diagram 900 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904a, b illustrated in FIG. 4. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the container validation program 110a in client computer 102, and the container validation program 110b in network server 112, may be stored on one or more computer-readable tangible storage devices 916 for execution by one or more processors 906 via one or more RAMs 908 (which typically include cache memory). In the embodiment illustrated in FIG. 4, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the container validation program 110a, 110b can be stored on one or more of the respective portable computer-readable tangible storage devices 920, read via the respective R/W drive or interface 918 and loaded into the respective hard drive 916.

Each set of internal components 902a, b may also include network adapters (or switch port cards) or interfaces 922 such as a TCP/IP adapter cards, wireless wi-fi interface cards, or 3G or 4G wireless interface cards or other wired or wireless communication links. The software program 108 and the container validation program 110a in client computer 102 and the container validation program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the container validation program 110a in client computer 102 and the container validation program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure or on a hybrid cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

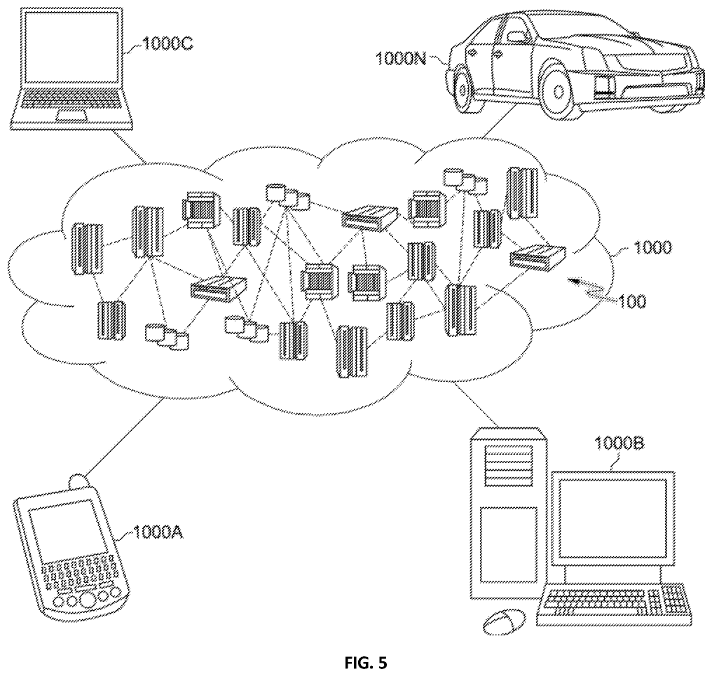

Referring now to FIG. 5, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 5 are intended to be illustrative only and that computing nodes 100 and cloud computing environment 1000 can communicate with any type of computerized device over any type of network and/or network addressable connection (e.g., using a web browser).

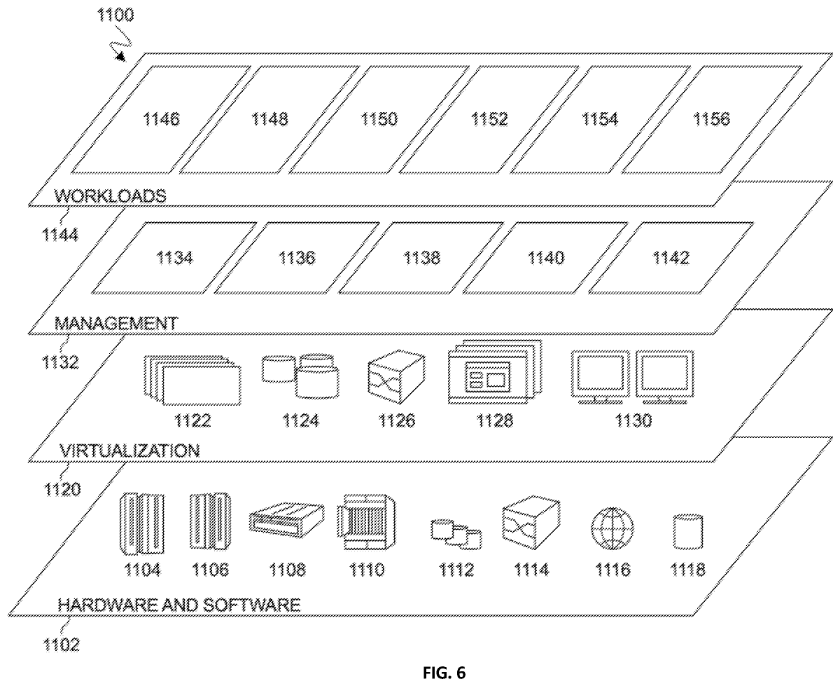

Referring now to FIG. 6, a set of functional abstraction layers 1100 provided by cloud computing environment 1000 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and container validation 1156. A container validation program 110a, 110b provides a way to validate and authenticate the communication between the microservice, the container and the SaaS. Additionally, security is provided using salt files and hash calculations within the communication over a communication network 116.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
configuring a container within a microservice framework;
receiving a generated salt file;
injecting the salt file into the container; and
hashing the container image and the salt file.

2. The method of claim 1, further comprising:
initiating, by the container, authentication with a software service;
receiving, by the software service, authentication initiation from the container;
generating, by the software service, a salt file;
transmitting, by the software service, the generated salt file to the microservice framework; and
initiating a key exchange between the software service and a client.

3. The method of claim 1, further comprising:
generating, by a software service, the salt file;
hashing, by the software service, the salt file;
transmitting, by the software service, the salt file to microservice framework;
transmitting, by the microservice framework, the hash to the software service; and
validating, by the software service, the hash file.

4. The method of claim 1, further comprising:
hashing, by the container, the salt file and a target file;
transmitting, by the container, the hashed salt file and target file to a software service; and
validating, by the software service, the hash file.

5. The method of claim 1, wherein the container configuration receives an environment variable from the microservice framework.

6. The method of claim 1, wherein the salt file is generated by a software service.

7. The method of claim 1, wherein the salt file is transmitted for key exchanges between the microservice framework, a software service, a container and a client.

8. A computer system comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
configuring a container within a microservice framework;
receiving a generated salt file;
injecting the salt file into the container; and
hashing the container image and the salt file.

9. The computer system of claim 8, further comprising:
initiating, by the container, authentication with a software service;
receiving, by the software service, authentication initiation from the container;
generating, by the software service, a salt file;
transmitting, by the software service, the generated salt file to the microservice framework; and
initiating a key exchange between the software service and a client.

10. The computer system of claim 8, further comprising:
generating, by a software service, the salt file;
hashing, by the software service, the salt file;
transmitting, by the software service, the salt file to microservice framework;
transmitting, by the microservice framework, the hash to the software service; and
validating, by the software service, the hash file.

11. The computer system of claim 8, further comprising:
hashing, by the container, the salt file and a target file;
transmitting, by the container, the hashed salt file and target file to a software service; and
validating, by the software service, the hash file.

12. The computer system of claim 8, wherein the container configuration receives an environment variable from the microservice framework.

13. The computer system of claim 8, wherein the salt file is generated by a software service.

14. The computer system of claim 8, wherein the salt file is transmitted for key exchanges between the microservice framework, a software service, a container and a client.

15. A computer program product comprising:
one or more computer-readable tangible storage media and program instructions stored on at least one of the one or more computer-readable tangible storage media, the program instructions executable by a processor to cause the processor to perform a method comprising:
configuring a container within a microservice framework;
receiving a generated salt file;
injecting the salt file into the container; and
hashing the container image and the salt file.

16. The computer program product of claim 15, further comprising:
initiating, by the container, authentication with a software service;
receiving, by the software service, authentication initiation from the container;
generating, by the software service, a salt file;
transmitting, by the software service, the generated salt file to the microservice framework; and
initiating a key exchange between the software service and a client.

17. The computer program product of claim 15, further comprising:
generating, by a software service, the salt file;
hashing, by the software service, the salt file;
transmitting, by the software service, the salt file to microservice framework;
transmitting, by the microservice framework, the hash to the software service; and
validating, by the software service, the hash file.

18. The computer program product of claim 15, further comprising:
hashing, by the container, the salt file and a target file;
transmitting, by the container, the hashed salt file and target file to a software service; and
validating, by the software service, the hash file.

19. The computer program product of claim 15, wherein the container configuration receives an environment variable from the microservice framework.

20. The computer program product of claim 15, wherein the salt file is generated by a software service.
